(19) United States
(12) Patent Application Publication
(10) Pub. No.: US 2004/0135547 A1
(43) Pub. Date: Jul. 15, 2004

(54) Method for controlling the electrical battery power in a motor vehicle

(76) Inventors: Mark Eifert, Muenchen (DE); Tom van Dongen, Gilze (NL)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/712,079

(22) Filed: Nov. 13, 2003

(30) Foreign Application Priority Data
Nov. 15, 2002 (EP) 02102591.1

(51) Int. Cl. H02J 7/00

(52) U.S. Cl. 320/132

(57) ABSTRACT

Method for controlling the electrical battery power in a motor vehicle The invention relates to a method for controlling the battery power which is supplied to or drawn from a battery (5) of a motor vehicle. In this case, a cost function is calculated which represents a measure of the additional fuel consumption in relation to the total electrical power generated by this additional consumption. The optimal battery power is then determined such that the cost function is minimized, i.e. the total electrical power is generated as efficiently as possible, corrections being made to the calculated optimal battery power in order to keep the battery within a predetermined state of charge range.

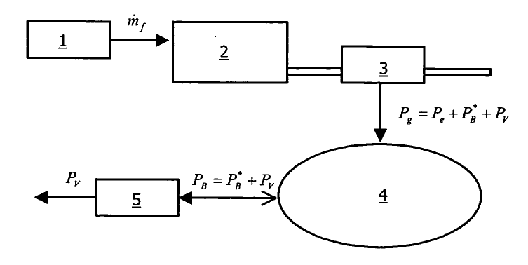

The invention relates to a method for controlling the electrical battery power which is supplied to or drawn from the battery of a motor vehicle and is coupled to the power supply system of the motor vehicle, the total electrical power consumed by the motor vehicle being generated by a generator which is coupled to the internal combustion engine of the motor vehicle. The invention further relates to a controller for carrying out a method of this type.

Coupled to the electrical power supply system of a motor vehicle are the electrical loads of the motor vehicle and, generally, a rechargeable battery. The electrical energy drawn from the power supply system is generated by a generator which is driven by the internal combustion engine of the motor vehicle. The battery coupled to the power supply system serves the purpose of forming an energy store or a buffer store in order to make available at any time sufficient power for, for example, starting the internal combustion engine.

The supply of electrical power to the electrical power supply system by the generator is controlled in conventional charge controllers such that a specific voltage above the no-load voltage of the battery is set in order to keep the state of charge of the battery at almost 100%. In this manner, the voltage in the power supply system should be kept at a constant value and sufficient energy should always be available for starting the internal combustion engine. However, from the point of view of efficient energy utilization, a control strategy such as this is not good, since a large amount of energy is lost in gas reactions in the battery in this method. It is also not advisable to have a state of charge of nearly 100% when a regenerative braking system is used, since a battery with such a state of charge can scarcely absorb the electrical power released during regenerative braking. Battery charging systems have therefore been proposed in which the state of charge is kept within a window or at around an operating point which is considerably below 100%. A system such as this is disclosed, for example in U.S. Pat. No. 6,091,228. A further phenomenon in the case of known motor vehicles is that the generator does not generate electrical power with equal efficiency in all engine operating states. For example, when the engine is idling, any additionally generated power tends to require increased additional use of fuel for power generation than is the case, for example, when the engine is in its normal operating mode with greater torques being developed.

Against this background, the object of the present invention was to provide a method for controlling the electrical power drawn from or supplied to a battery (battery power) which allows improved utilization of the fuel consumed.

This object is achieved by a method having the features of claim 1 and by a controller having the features of claim 7.

Advantageous refinements are described in the subclaims.

The method according to the invention serves the purpose of controlling the electrical battery power, regarded by way of definition as being the electrical power which is supplied to or drawn from a battery of a motor vehicle which is coupled to the power supply system of the motor vehicle. Conventionally, in this case, for example, power supplied to the battery may have a positive value and power drawn from the battery may have a negative value. In this method, the total electrical power consumed by the motor vehicle (i.e. from the power supply system including the battery) is generated by a generator which is coupled to the internal combustion engine of the motor vehicle. The method is characterized by the fact that a cost function is calculated having a value which represents a measure of the additional fuel consumption, which is required for the generator to generate the total electrical power, in relation to the total power generated by this additional consumption. With the aid of this cost function, an optimal value for the battery power is then determined such that the value of the cost function is at a minimum when the optimal value is set.

The cost function used in the method reflects the efficiency of the electrical power generation since it establishes a relationship between the fuel consumption and the electrical power thus generated. The lower the value of the cost function, the more efficiently the fuel is converted to electrical energy.

The dependence of the cost function on various state variables and parameters can be derived by theory and/or determined empirically. It is evident here that, under certain basic conditions, when the electrical power generated has a specific value, the fuel utilization is optimal, i.e. the value of the cost function is at a minimum. In the method explained, the battery power is treated as a variable parameter having a value which is determined such that the cost function is minimized. It is possible to increase the total power consumed by the power supply system by charging the battery and to decrease it by discharging the battery. By changing the battery power it is thus possible to alter the total power consumed to a value at which the cost function is at a minimum. Electrical energy is then always made available to the power supply system at an optimal fuel utilization level.

In accordance with a preferred refinement of the method, the battery charging losses are taken into account when determining the optimal value. Battery charging losses arise as a result of the real physical and chemical processes and can be quantified by determining the difference between the electrical energy supplied to a battery during charging and the energy which can be drawn from the battery again during discharging. By taking the battery charging losses into account it is possible to optimize the electrical power generation more realistically since this reduces the costs for the use of the battery as a buffer store.

With the abovedescribed embodiment of the method, the battery charging losses are preferably determined by continually averaging the measured efficiency of the battery charging and battery discharging. In this manner, the parameters relevant to the battery charging losses can be kept constantly at an updated value.

In accordance with another development of the method, the battery power which is actually set is greater than the calculated optimal value if the state of charge of the battery is lower than a predetermined value and less than the calculated optimal value if the state of charge of the battery is greater than a predetermined value. This correction of the optimal value makes it possible to ensure that a desired predetermined value for the state of charge of the battery is roughly maintained or that the state of charge of the battery is kept within a predetermined window.

A preferred addition to the method is a procedure pertaining to the regenerative braking of the motor vehicle. In the case of regenerative braking, the braking energy is partially converted to electrical energy. The kinetic energy stored in the movement of the vehicle is therefore not converted fully to frictional heat—and thus lost to the energy balance—but is predominantly converted to useful electrical energy.

Regenerative braking is preferably carried out in a gear which maximizes the electrical energy generated or the flow of energy to the battery.

The invention further relates to a controller for controlling the electrical battery power which is supplied to or drawn from the battery of a motor vehicle which is coupled to the power supply system of the motor vehicle, the total electrical power consumed by the motor vehicle being generated by a generator which is coupled to the internal combustion engine of the motor vehicle. The controller is characterized by being designed to carry out a method as described above. The controller can thus calculate a cost function which determines the ratio of the excess fuel consumption to the total electrical power thus generated. The controller can also determine and set an optimal value for the battery power such that said cost function is kept to a minimum.

An important aspect of the present invention is that not only is the state of charge (SOC) of the battery, which can be determined approximately by means of various known methods, for example using the battery voltage, the battery temperature and the battery power, used for the charging procedure, but the fuel efficiency of the energy generation by the generator is also taken into account by introducing a cost function as well. This leads, for example, to more electrical power being made available via the battery when the internal combustion engine is idling, as long as the state of charge of the battery allows it, in order to increase the fuel efficiency overall. The power drawn in this state is fed back to the battery at times when the generator is operating more energy-efficiently or in the case of regenerative braking. Despite the battery charging losses, this may result, overall, in a fuel saving.

The invention is explained by way of example below with the aid of the attached FIGURE. The single drawing shows the system components which are involved in carrying out the method according to the invention.

The drawing shows, firstly, an internal combustion engine 2 which, in a known manner, produces mechanical power whilst a fuel mass flow \dot{m}_{f} is supplied from a fuel tank 1. Part of this mechanical power is tapped off by a generator 3 which is coupled to the crankshaft of the internal combustion engine 2, and converted to electrical power P_{g}. The electrical power P_{g} is supplied to the power supply system 4, illustrated symbolically, of the motor vehicle. All of the electrical loads are connected to the power supply system 4, the electrical power required by these loads being denoted Pₑ.

A rechargeable battery (accumulator) 5 is furthermore coupled to the power supply system 4, the electrical power P_{B} being exchanged between the power supply system 4 and the battery 5. The mathematical sign system for the power P_{B} is selected here such that when the battery is charged P_{B}>0 and when the battery is discharged P_{B}<0.

Furthermore, it can be seen in the FIGURE that the battery power P_{B} comprises two parts: firstly a reversible battery power P_{B}*, which describes the energy component which can be drawn from the battery 5 again up to 100%, and secondly a battery charge loss P_{V}, which is lost irretrievably whenever the battery 5 is charged or discharged.

Whilst conventional methods for controlling the battery charging try to maintain a constant voltage from the battery 5, in this case, in order to improve the fuel utilization, a strategy is proposed in which the generator 3 generates a variable amount of electrical power. This strategy comprises two parts, firstly an optimal charging method with the motor vehicle being driven in a positive sense, and secondly a method of regenerative braking when the mechanical brakes of the motor vehicle are active.

During the optimal charging procedure, the current operating point of the generator 3 is calculated using an optimization algorithm for converting chemical power, expressed as fuel mass flow \dot{m}_{f}, in relation to the electrical power P_{g} required by the electrical loads. This optimization determines whether the battery 5 is charged or discharged or whether any charge transfer has taken place at all with the battery 5.

This decision is made on the basis of a cost function J. This is done by measuring the total power P_{g} required by the electrical loads (including the battery 5). This total power P_{g} must be generated by the generator 3, which results in additional fuel consumption by the internal combustion engine 2. The increase in the fuel mass flow Δ\dot{m}_{f} in relation to the normal fuel flow required for the movement of the motor vehicle can be determined. The cost function J can then be calculated as the ratio of additional fuel consumption to total power in accordance with:

$$J = \frac{Δ {\dot{m}}_{f}}{{BSFC}_{Best} \cdot {P}_{g}} = f ( n , T , {P}_{g} )$$

in which BSFC_{Best} is the best specific consumption value of the combustion engine, n is the current rotational speed of the internal combustion engine 2 and T is the torque produced by the internal combustion engine 2. The cost function is normalized with respect to the best possible specific consumption in order to achieve a value for it which is always at least, and is ideally, unity. This normalization allows a comparison to be made between different combustion engines.

As has been explained above, the total power P_{g}, which is supplied to the power supply system 4 by the generator 3, comprises the power P_{B} consumed by the battery and the power Pₑ consumed by the other electrical loads. The battery power in turn comprises a reversible component P_{B}*, which can be drawn from the battery again without losses, and a battery charging loss P_{V}, i.e.:

P_{g}=Pₑ+P_{B}=Pₑ+P_{B}*+P_{V}.

The battery losses P_{V} occurring in the battery are measured and used during charging and discharging by means of a sliding time window in order to calculate the average charging and discharging efficiencies. The average battery charging losses obtained from this are in this manner kept continuously up to date.

By changing the battery power P_{B}, the total power P_{g} can be varied and the cost function J can thus be influenced. This can be utilized, in particular, to shift the total power as near as possible to a minimum of the cost function, i.e. to generate electrical power from fuel as efficiently as possible. The optimal value, which is associated with such a minimum of the cost function, of the battery power is indicated by P_{B,opt} in this case. This optimal value can be calculated by means of numerical approximation methods from the above relationships.

In order to maintain a predetermined nominal state of charge (SOC) of the battery, a correction is then further made to the calculated optimum battery power P_{B,opt}. If the measured instantaneous state of charge SOC of the battery 5 is lower than the desired SOC, the optimum battery power P_{B,opt} is increased. If, on the other hand, the instantaneous SOC is above the desired SOC, the optimum battery power is reduced.

If the motor vehicle is not being driven but braked, in a regenerative braking procedure, energy is obtained from the braking process and converted to electrical energy. In this case, a gear is preferably selected which maximizes the energy flowing into the battery 5.

1. A method for controlling the electrical battery power which is supplied to or drawn from the battery (5) of a motor vehicle and is coupled to the power supply system of the motor vehicle, the total electrical power (P_{g}) consumed by the motor vehicle being generated by a generator (3) which is coupled to the internal combustion engine (2) of the motor vehicle,
characterized in that
a cost function is calculated which represents a measure of the additional fuel consumption based on the total electrical power generated by this additional consumption, and in that an optimal value for the battery power is determined such that the cost function is minimized.

2. The method as claimed in claim 1,
characterized in that
the battery charging losses (P_{V}) are taken into account when determining the optimal value.

3. The method as claimed in claim 2,
characterized in that
the battery charging losses (P_{V}) are determined by continually averaging the measured efficiency of the battery charging and battery discharging.

4. The method as claimed in claim 1,
characterized in that
the set battery power is greater than or less than the calculated optimal value in order to keep the state of charge of the battery (5) within a predetermined value range.

5. The method as claimed in claim 1,
characterized in that
regenerative braking of the motor vehicle is carried out in which the braking energy is converted at least partially to electrical energy.

6. The method as claimed in claim 5,
characterized in that
the regenerative braking is carried out in a gear which maximizes the generated electrical energy.

7. A controller for controlling the electrical battery power which is supplied to or drawn from the battery (5) of a motor vehicle which is coupled to the power supply system (4) of the motor vehicle, the total electrical power (P_{g}) consumed by the motor vehicle being generated by a generator (3) which is coupled to the internal combustion engine (2) of the motor vehicle,
characterized in that
a cost function is calculated which represents a measure of the additional fuel consumption based on the total electrical power generated by this additional consumption, and in that an optimal value for the battery power is determined such that the cost function is minimized.
